(19) United States
(12) Patent Application Publication
(10) Pub. No.: US 2009/0008443 A1
(43) Pub. Date: Jan. 8, 2009

(54) Information Storage Tag System for Use and Method

(76) Inventors: Yeruchem J. Levovitz, Spring Valley, NY (US); Vasu S. Iyengar, Plainsboro, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/666,765

(22) PCT Filed: Oct. 31, 2005
(86) PCT No.: PCT/US05/39081

§ 371 Date: Jul. 23, 2008

Related U.S. Application Data
(60) Provisional application No. 60/631,123, filed on Nov. 3, 2004.

(51) Int. Cl. G06K 19/00; G06K 5/00; G06Q 50/00

(52) U.S. Cl. 235/380; 235/487; 705/3

(57) ABSTRACT

Medical information storage tags to be carried on a person have two separate data storage devices on a base. Each has a data reader or reader/writer interface. Read only data storage identifies the bearer and provides vital medical information required for emergency treatment; it can be accessed by a data reader only, preferably with a printer. A read and write data storage area prerecords encrypted medical history data using industry standard formats that can be amended or deleted. Access to the read and write data storage is restricted to designated users by security means. Both data areas provide personal identification of the bearer name and address, a photo of the bearer, name and contact information to reach the bearer's doctors and next of kin. Both areas may also include financial and insurance information. Means is provided for forwarding data from ambulance to a designated receiving hospital, such as a radio link.

The present invention relates to an information storage device to be carried on a person to provide medical and financial information about the bearer. Preferably it is a device in the form of a tag which can be carried as a key fob by an individual and which itself is a key which supplies easily accessible stored information.

Preferably the tag carries information at two levels, one to store essential information for emergency rescue personal and another for information possibly needed by doctors and hospital personnel for comprehensive diagnosis and treatment. If the bearer of the tag is found unconscious or unable to communicate, the information stored on the tag is in a form which can be easily accessed and quickly printed out. Preferably the location of information stored on the device and accessible through an interface is visually or tactilly coded as by alpha numeric or color coding or surface feel to identify access to the specific desired data. Thus, desired emergency information can be accessed quickly, with the access for each storage device being immediately accurately identified for what it is. Emergency essentials are then made available without the clutter of the medical history. In its separate storage area, more comprehensive medical history is provided in at least sufficient detail to enable doctors to safely attack urgent medical problems and treat the bearer appropriately as a patient about whom pertinent medical information is known.

In the prior art, various types of emergency information have been provided from military “dog tags” and med-alert bracelets on which only the barest essential information is usually printed. Other devices allow a conscious, but disabled patient to contact others by telephone or radio to obtain help to send a pre-recorded message identifying the patient by name and address location.

The present invention solves many problems not fully addressed by the prior art. A very simple passive tag provides a support base for a data storage device for storing emergency information in a standard form that can be read by commercially available data readers designed to be accessible to the pick-up of the reader. When a person wearing such a tag is found and picked up by an ambulance or an emergency crew, or brought to an emergency room, the first contact needs to be with medics who have readers for the emergency data on the tag, preferably printers to produce a printed output of the data. The tag has some sort of standard data storage location indicator on its surface to help locate and access immediately the essential information provided to safely take whatever emergency steps are necessary to aid the victim without endangering his life. All sorts of essential information about the individual can be recorded, including blood type, positive or negative Rh and, allergies, particularly to drugs and other substances that can cause violent reactions. Medical conditions of the particular patient which might suggest known illnesses, medications to be taken or avoided and anticipated aids and problems. Examples of such problems might be seizures or heart problems. Possible emergency treatment for those problems may be suggested in the data, as well as treatments to avoid them. While this emergency information needs to be kept brief, other potential medical problems and other health information that might be vital for emergency medics to know at once to avoid making mistakes in trying to help the patient can also be recorded.

The tag preferably has at least two separately accessed data storage devices, including a second storage device in which comprehensive medical information for doctors and others can be stored. In addition the wearer's primary physician, and perhaps specialists who are knowledgeable about emergency problems that might arise, and how to contact such knowledgeable people in case of emergency to obtain further medical information for aid in diagnosis and treatment may be included. Hospitals and other treatment facilities are also often concerned about whether the bearer has insurance and of what kind he or she might have. A brief resume of such information may be desirable even in the brief emergency data. In fact, the system can include secure radio links to banks to order pre-approved transfer of finds for co-payments and other payments required before admission to a hospital. A return signal that acknowledges transfers have been made from the patient's bank may be received and information confirmed and even payments made while he is still in the ambulance on the way to the hospital. In the detailed medical history, details about medical insurance coverage which the individual has, as well as his ability to pay may be included. The medical history part should also include financial and other information which hospitals require for admission for the hospital records in a form which may be easily transferred to hospital records.

Because such detail included in a comprehensive medical history, which might be invaluable to a doctor in evaluating treatment beyond the field emergency phase, could clutter the emergency information and delay desperately needed emergency treatment, separating such different kinds of information, and yet being able to quickly access each, is important. The emergency information can be kept brief and limited to vital information which can even be standardized to further aid in rapid use. Each data base stored on the tag most importantly needs to be easily and conveniently readable. Its output should also preferably be provided in tangible printed form for clarity and follow up references during subsequent emergency treatment, even though the print is shredded for security or kept for secure files of those who must handle and treat the patient.

The system prints everything, even matter which must not be allowed to go beyond medical staff as privileged private information. There must normally be a document shredder available for the ambulance to keep secret such printed out confidential privileged information. On the other hand financial authorization for checks with private information identifying accounts and other personal information must be transmitted back and forth by secure means and might not be part of the emergency information printed out. The same sort of security may be necessary for contacts with the insurance carriers listed, possibly with an automatic code to activate transmission of pertinent messages, sufficient at least to allow the patient to be admitted to the hospital. In preferred form the present invention relates to an information storage and transmission device to be carried on the person identified to provide medical and financial information about the bearer. The physical tag preferably needs to be kept small and unobtrusive. Advantageously it may be a tag which could be worn as a key fob or on a bracelet or necklace and marked to be quickly identifiable for what it is, preferably with brief printed instructions as to its use. Separate data storage is provided by conventional storage medium on defined portions of the base and provided with read/write interface devices permitting receiving and storing data in a form and the manner that it can be read and printed and preferably capable of being accessed for use, through the same interface. At least the medical history storage device is preferably capable of receiving and recording new data or having existing data amended, deleted, or otherwise modified in the field, preferably by specialized equipment provided for such purposes and adapted to receive and read the stored data. Security provisions preventing at least modification of data or addition thereto, for example, without an access code, are very desirable. Security means encrypting or decrypting coded data may be of great value but needs to be invisible to users of the data in emergency. To that end, they may be incorporated, into printers or other readers authorized to receive the data and will serve to prevent unauthorized equipment from accessing the confidential data.

Also, in accordance with the present invention, an information storage and access system is provided comprising a plurality of medical information storage tags of the type described and specifically storing data specific to each individual tag bearer. Each tag has a support base providing at least two visually or tactilly identified data storage areas and their interface terminals, one for emergency treatment use and one for medical history for use in the medical treatment of patients.

More specifically the present invention relates to an information storage tag to be carried on a person to provide medical and financial information about the bearer. The tag employs a support base for storage devices to store specified categories of information. Separate data storage means are provided on different portions of the base each capable of receiving and storing data in a form and manner that it can be read with or without encryption. Data necessary for emergency treatment can be retrieved from one area of the data storage device on the base and made accessible to emergency treatment personnel to aid in immediate treatment and prevention of mistreatment of the bearer while being transported from an accident. The other data storage device may also be capable of receiving and recording new data or having existing data amended, deleted or otherwise modified. That data storage device stores detailed, at least semi-permanent medical history data essential to identifying the individual and providing as nearly as possible all vital medical information required by a physician. This more complete medical history storage device is preferably intended for modifiable data that can be accessed and added to or changed by physicians, therapists and personnel treating the bearer beyond an early emergency stage.

The data for first aid emergency treatment is preferably stored in a read only data storage device which can easily and quickly be read and the data preferably printed to provide the emergency aid reader with a tangible permanent record of the information. That record will be available for review as treatment proceeds but, when no longer needed, easily destroyed by a shredder there in the ambulance or other emergency station unless a printout is preserved as part of the treatment file under secure storage. Another reason the printer is preferably used is printing employs no radio or other signal that might be intercepted for improper purposes so that security is maintained. However, the system of the invention does not absolutely have to require printing to be useful. Therefore, some systems may be designed so that the read only data can possibly be the only means of display by a dedicated reader with or without a printer. In either event, access may be permitted only to a reader having a firewall, a key or code password. In addition, the read only portion may contain a picture of the bearer for identification together with name and address and identifying information of interest to a hospital and physicians and to banks and insurers to make sure the transported individual is the same as the intended bearer of the tag. Picture identification of the bearer before forwarding information to banks and insurers can only be done by the emergency personnel or others with them after the picture has been printed out. Transmission to banks and insurers should ordinarily be delayed by the transmitter program pending an identification okay by the emergency personnel.

The other modifiable data storage area may be capable of receiving and printing of the record with or without a password. However, recording new data or having existing data amended, deleted or otherwise modified, should in most instances require a password or other means of limiting access. The more detailed data, for example, may also be helpful to further identify the individual wearing the tag and providing vital medical information for treatment of that person which can then be modified to reflect the treatment provided and the time, place and at least one responsible physician involved in the treatment. Prior agreement with hospitals where such modification must conform to regulations for data modification of the medical history and normally requires that the data must be secure. The print only information and all information, must at least comply with existing Health Insurance Portability Act Laws related to security of health information and data transmission requirements. All modifiable data that is vulnerable to mischief must be made secure in some approved way.

The invention also relates to an information storage and access system comprising a plurality of individual medical information tag storage devices, used for different persons, each carrying one such device specifically providing emergency and medical history data about the bearer. Each such device is provided on a support base designed to be conveniently carried and each tag has at least two identifiable data storage devices as described above.

The system also employs a plurality of data readers for the read only data storage. The data readers are to be provided in ambulances and all types of receiving stations where persons who are not able to help identify themselves or their problems may be received. In such locations their data storage devices may be used for the purpose of permitting identification of the individual and providing basic information on blood and Rh type and allergies and excluding or limiting treatments or disclosing precautions required in emergency treatment of that individual.

A plurality of data generators/readers under the control of designated emergency personnel and physicians for reading and changing any modifiable data to allow updating the medical history of the individual and to specify diagnoses, and information about the patients condition as well as permitting updating of that data in view of current treatment as needed in the judgment of qualified medical personnel who should be identified.

The invention also relates to a method of providing medical information for emergency treatment which incorporates the following steps:

Providing personal identification and emergency medical information data relating to each of a plurality of people on memory incorporated into personal lightweight data storage tags of standard configuration for each person, each device having at least two data storage devices, one a read only storage area and the other a read and write storage area so that the data stored in the latter area are capable of being deleted, modified and added to.

Providing devices for installation in emergency receiving stations, such as ambulances, hospital emergency rooms and other facilities for receiving and treating persons who are victims or in need of urgent treatment, said devices being capable of receiving the standard lightweight data tags in a position to interface with the read only data output is positioned to output and produce an understandable output for the emergency personnel.

Providing read and write devices for installation in follow up medical facilities where doctors and their staff can use them to access more comprehensive medical history information for treatment of patients having the standard lightweight data tags, such that the read and write data devices are capable of receiving and guiding the standard tag to a position in which the read and write data is positioned to interface with the read and write data input and output so that it can produce a readable output for aid in diagnosis and treatment of the patient and permit authorized persons to access and delete, modify and add to the data based upon current treatment of the patient.

Installing such devices as intended and using them with the data storage tags of patients for emergency treatment after creating a proper interface with the data base intended identified by visual or tactile identification of the appropriate interface.

For a better understanding of the present invention reference is made to the accompanying drawings in which

FIG. 1 is a schematic representation of a key fob tag incorporating the separate areas for storing medical information data about the bearer;

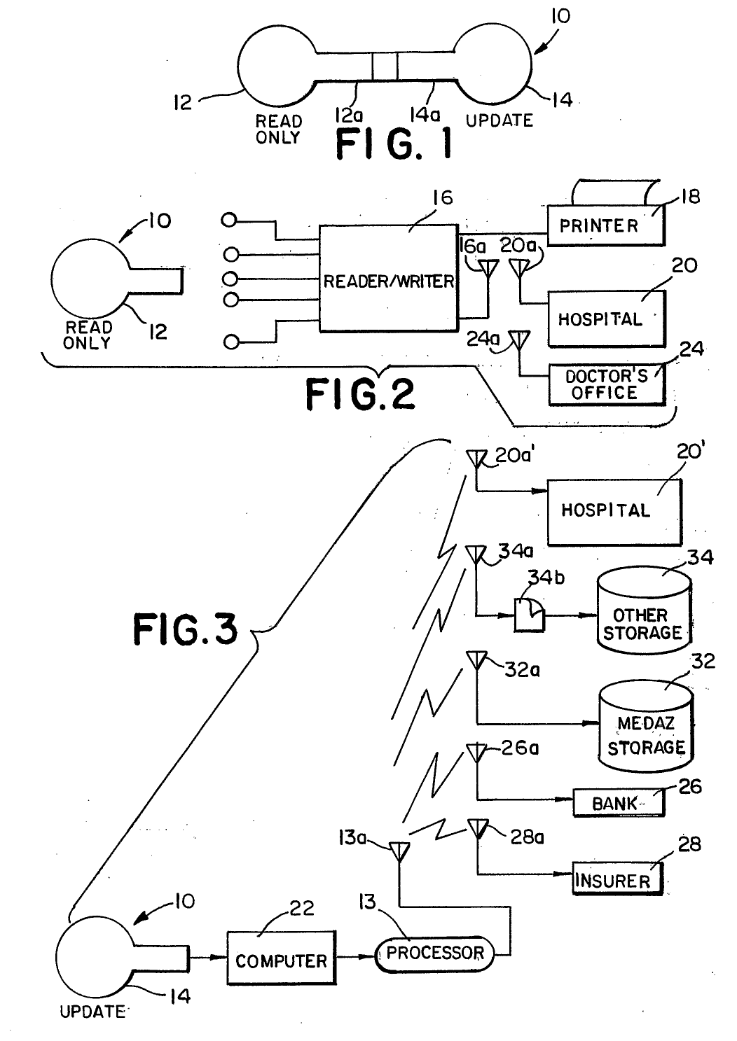

FIG. 2 represents a schematic processing diagram for the read only portion of the memory and represents such information being read and printed out;

FIG. 3 represents a schematic processing diagram for the modifiable portion of the memory showing how the medical data is processed and forwarded to hospitals and doctors and financial information is forwarded to banks and insurers for confirmation and initiating payment and the billing process;

FIG. 4 is an elevational view from above of a physical embodiment of a double ended key in accordance with the present invention;

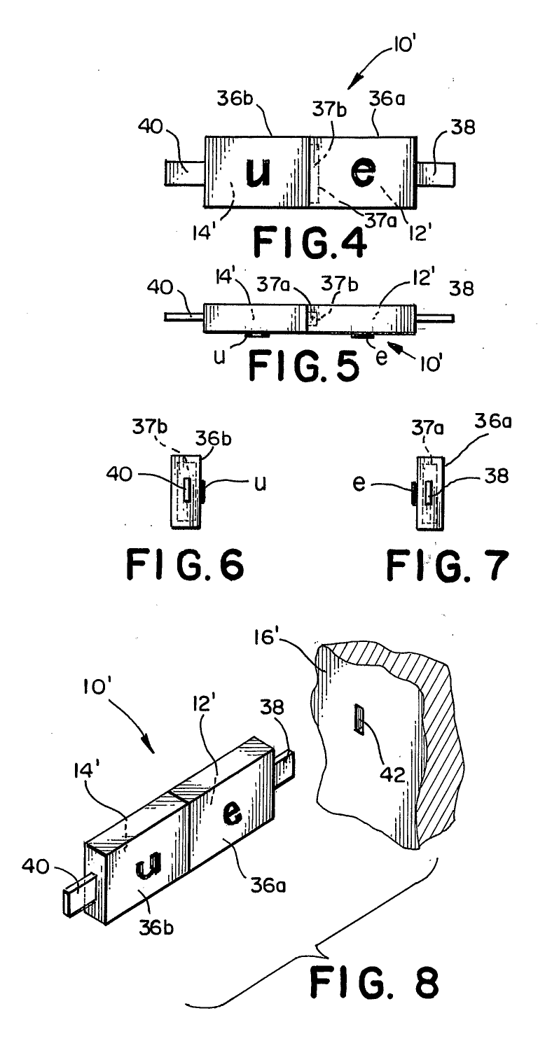

FIG. 5 is a top edge view of the key of FIG. 1;

FIG. 6 is an end view of the key as viewed from the left end of FIG. 4;

FIG. 7 is an end view of the key as viewed from the right end of FIG. 4; and

FIG. 8 is a partial perspective view of a tag of FIGS. 4-7 and the port area for receiving an interface terminal of the tag.

FIG. 1 schematically shows the tag of the present invention, generally designated 10, which in one preferred form can be made of corrosion resistant high impact lexan plastic and carbon composite compound. Digital memory chips 12 and 14 are shown at opposite ends of the elongated structure. The key support may be completed in the configuration shown and folded so that the chips lie side by side with interface areas 12a and 14a on opposite sides of a tab terminal. Alternatively, the storage areas may be moved closer together and their respective interface terminals brought out opposite ends to form a tag with terminals at both ends, for the respective data storage devices. The tag may be only 2 to 3 inches in length and approximately one half inch in width, and can be smaller as required in a particular application. It preferably employs a radio frequency information device (RFID) and/or flash ram memory depending upon required capabilities. Its memory chips are similar to and can be downloaded in the same way as a digital picture can be downloaded key-like from a “memory stick”, similar to those now commonly used on a digital camera. In fact, at least one memory storage preferably includes personal identification, including an i.d. photo of the bearer, the bearer's name and address. Diagrams or charts as well as printed text may also be stored using this photo storage format. It also potentially provides ability to cooperate with various types of display devices for viewing data in non-proprietary use and for common language interface anywhere in the world without further development. In the present proposed emergency use, at least for the emergency output, the read only memory device is protected by encryption for download at emergency locations in the field with the principal and preferred output being a printer producing printed paper. For entire patient medical history upload it provides a 1061 bit SSL. This configuration is designed to allow open architecture interface with sufficient security specifications to comply with HIPPA regulations, and the Century 21 Banking Act.

FIG. 2 represents the read only data storage device 12 being positioned to feed details to the read only emergency download portion in connection to the reader/writer hardware and software combination and appliance interface, which may be a USB or firewire port in the printer 16 for wired or wireless interface between reader/writer interface to deliver instant printout on printer 18 in form for immediate use by medics. Because of security concerns, a wired output printer is preferred for printing out hard copy of personal and medical data for field emergency use. Printer 18 can be a stripped down basic computer printer and preferably should be standard in all emergency vehicles and receiving stations. Most emergency personnel already carry personal digital assistant (PDA) device, or a tablet or other such device with RFID capability. This interface capability will allow for PDA and Palm downloads for FTP transfer forward capability from emergency vehicles and/or receiving stations to emergency facilities at the hospital. In addition if a picture of the bearer is included and printed out, confirmed identification normally can be made by emergency personnel for physicians, banks, hospitals and insurers en route to the hospital. Other personal information may be printed as well and forwarded to clearance personnel for specific needs. Financial information can be forwarded by secure transmission, for instance a check routing to banks for withdrawal of funds for co-pay payments to the ambulance, hospital and physicians, and medical insurance information to the insurer to facilitate hospital admission.

FIG. 3 shows automatically update computer 22 hardware and software combination tag 14 using flash ram or RFID. Memory storage 14 is used for a complete patient medical history dossier as well as American Banking Association routing and checking account numbers and for processing transfer of initial co-pay bill portion payments and medical data simultaneously, securely transmitted for uploading into secure computer systems in doctors offices and/or at hospital locations. Such transfers may be for use in total processing of medical information for treatment and diagnostics as well as at the patient's banks and insurance company for financial clearance. Then updated confirmation from bank and insurer are transmitted securely out again back to the medical history data storage which can be designed to store such new data for future use in tracking patient history throughout the life of patient. The tag 10 is to be carried by patient at all times and can be attached as a fob with mechanical keys, or worn as a pendant or bracelet. The tag may also be used to transfer appropriate information for storage purposes to appropriate designated records in any and all medical storage locations and bank and insurance records.

Referring now to FIGS. 4-8, a modified version of the tag in accordance with the present invention as shown. The tag 10′ is essentially of the same nature but shown in a practical use form slightly modified in configuration from the schematic showing in FIGS. 1-3. In this version the read-only memory 12′ actually has a separate housing 42 from the housing 44 for the read and write memory storage device 14′. The storage devices can be memory chips of the read-only type and the read and write type, respectively. The read and write chip preferably can be accessed only by authorized personnel and can be written upon only by a few designated personnel. This can be provided by using encryption of the data and providing special decrypting means on designated readers, including printers. To keep unauthorized personnel from modifying the read and write data storage device, a password providing ability to change data can be given only to those who need to know. It may be necessary to provide separate storage devices which allow writing by different people for medical, banking and insurance. For example, the physicians who need to modify the medical history, use a password to access the write feature of the medical history. The bank may need to modify the financial information and their access to such data should be limited to personnel designed by the bank or the bearer patient. The insurance people may have occasion to modify the insurance portion and should be limited to the ability to write only in that portion of data storage. Each of these actors, if need be, may have the ability to read the entire chip, or if separate chips are used for separating access, but they are able to modify only the part that pertains to them.

In FIGS. 6 and 7, what was described previously as a base, takes the specific form of an enclosing housing which is molded with a hollow interior, as suggested by the dashed lines. In such structure the memory chip or chips will then need to be inserted into the hollow cavity and appropriately supported. Alternatively, the moldable resinous material used for the housing may be simply a simple molding which includes the chip or chips in the molding process. In that way the chips are part of the integral casting. Such procedure, of course, requires care and precision in the way that it is accomplished but may assure more solid support.

It should be noted that the housing in FIGS. 6-8 has been molded in two parts 36a and 36b, the former containing the read-only emergency information and the latter the medical history portion. The pieces are formed so that they normally are together with a tongue 37 on housing 36b fitting into a groove on housing 36a, such that there is a either a yieldable snap connection or a press-fit so that friction will hold the two pieces together. The possibility then exists of separating the pieces and carrying only one or the other or carrying them in different ways. The chip or chips 12′ have connection to the interface terminal 38 and the chip or chips 14′ forming the medical history part have an interface terminal 40. Either or both of these terminals may have a dedicated port 42 in the wall of writer 16′ as suggested in FIG. 8 and the interface terminals 38 and 40 may be operative only in the dedicated port or may be operable in the same port with separate port terminals positioned to engage interface portion for each memory. Providing a common port with terminals to cooperate with the effective parts of terminals 38 or 40 may require a predetermined orientation of inserted terminal to make the proper connections.

The data in the tag will be designed so that when the key is plugged into a printer such as the Canon printer it will get the decryption code from the printer and automatically print the information. The data will be loaded into the tag using a custom program provided to the guardian of the information, either a third party or the primary physician office. For example, there will be 2 physicians at each receiving hospital who will be set up as guardian of patient information. An option can be provided whereby the patient can designate specific independent agencies as the guardian of their information.

The respective storage devices can be identified in many ways, but color-coding and/or a simple key letter or number, such as the letter “e” which is raised to provide a distinctive tactile feel for use in the dark or other conditions of poor visibility. Similarly, a different raised letter such as “u” is used to designate the medical history data storage. If a single port is employed, and the effective interface surface is one-sided on each of the terminals, placing a corresponding letter, preferably also raised, to be tactically felt, may also be employed such that keeping the same letter on the tag and on the same side of the port will properly orient the interface of the tag when either terminal is inserted. Thus, for example, the designator “e” on the tag would be kept on the side of the “e” adjacent the port for proper interface connections to be made. Other means of properly orienting the tag or key are clearly within the scope of designers and can include using e.g., key-like intermitting ridges and grooves on each terminal 38 and 40 which allow only one orientation in the port to line up the interfaces for proper connection. The port 42 may also include encrypting or decrypting means so that the output to the printer or display will be legible and understandable and output from the port will be encrypted.

The tag of FIGS. 4-8 is merely one preferred embodiment of the structure. Obviously other forms of the tag can be employed. With the art of photo sticks and similar devices being very analogous to what is intended for use with the present invention, those skilled in the art will readily understand interface and chip and software elements that are available in the prior art that can be directly employed. This is not to imply that these are the only possible embodiments, but certainly provide a workable simple solution to what has become a conventional and easily used storage and exchange device in the prior art.

I claim:

1. An information storage tag to be carried on a person to provide medical information about the bearer, comprising
a support base for carrying coded information,
separate data storage devices on the base each with its own data reader or reader writer interface, providing one storage device capable of prerecording and storing emergency data in a read only form and another data storage device capable of prerecording medical history and recording new data while in the field or having existing data amended, deleted or otherwise modified, such that permanent data essential to identifying the individual and providing vital medical information required for emergency treatment can be accessed by a data reader from the read only area and detailed information relating to the individual's medical history can be accessed and added to as needed to provide for continuing and future treatment of the individual.

2. The information storage tag of claim 1 in which access to the read and write data storage device is restricted to designated users.

3. The information storage tag of claim 1 in which personal identification such as the name and address of the bearer is included in the data prerecorded on at least one of the data storage devices in a form not in the field.

4. The information storage tag of claim 3 in which a photo of the intended bearer is included in the personal identification data.

5. The information storage tag of claim 2 in which basic information other than the bearer's medical history, such as name, address, and telephone numbers and similar information about next of kin who could discuss and authorize recommended procedures, and contact information needed to reach bearer's doctors enabling the hospital and others having a need to know to discuss with family members and personal physicians recommended procedures before proceeding, if time and availability permits.

6. The information storage tag of claim 5 in which certain additional basic personal financial and insurance information may be provided and made accessible for readers only but modification of such can be done only through further security procedures not generally accessible to hospital staff and emergency personnel.

7. The information storage tag of claim 2 in which financial and medical insurance information necessary to insure the bearer's admission to a hospital or other places for necessary treatment may be included in either or both data storage devices in read only form, or in the medical history area in a form allowing modification only after a separate security procedure accessible only to designated personnel.

8. The information storage tag of claim 1 which is provided with visually or tactically sensed indicia for one or both data storage devices so that the interface connection for the respective devices can be connected with a reader which is appropriate by emergency personnel.

9. The information storage tag of claim 1 in which the tag is folded to form a fob so that the respective data storage devices and their interfaces are on opposite sides of the fob formed by folding.

10. An information storage and access system comprising a plurality of individual medical information storage tags, each on a support base designed to be conveniently carried and each support base having at least two identifiable data storage devices, one data storage device capable of receiving and storing emergency treatment data in a read only form, and the other data storage device being capable of reading recorded data, and at least for designated kinds of data, receiving and recording new data or having existing data amended, deleted or otherwise modified, but such that more detailed data helpful to further identifying the individual and providing vital medical information for treatment of that person can be accessed only with a data reader and writer designed to process it,
a plurality of data readers for the read only data storage device provided in ambulances and other types of receiving stations where a person bearing a data storage tag and who may or may not be able to help identify himself or his problems may be received and his storage devices read to permit identification of the individual and provide basic information limiting, or special precautions required in, emergency treatment of that individual, and
a plurality of data readers under the control of physicians or other pre-approved personnel for accessing the other data storage device to permit reading therefrom a more complete medical history of the individual.

11. The information storage and access system of claim 10 in which at least some of the data readers for accessing the medical history may also be able to write at least in some of that data storage device to add to or modify the medical history to maintain it current during or after treatment of the bearer.

12. The information storage and access system of claim 11 in which access to parts or all of the respective data storage devices are subject to security by password or other device limiting the persons who can see parts or all of the respective information storage areas.

13. The information storage and access system of claim 12 in which access to parts or all of the respective data storage devices are subject to security by encryption password or other device limiting the persons who can write in the respective information storage areas in which can be modified or added to.

14. The information storage and access system of claim 10 in which the reader provided to field emergency stations and ambulances will only read the read-only data for emergency treatment.

15. The information storage and access system of claim 10 in which the reader provided to hospitals will read and write to the extent provided by the designers in the medical history data area.

16. The information storage and access system of claim 15 in which two readers, one of which can also write to the extent permitted by the design of the equipment, are arranged on opposite sides of a reading port for receiving interface outputs of the data device on opposite sides of and positioned so that, when activated with the data areas properly oriented, either selected data area can be read and, when the data area that can be changed is selected, its writer can write as programmed to amend, delete or add to the medical history.

17. The information storage and access system of claim 10 in which the tag is shaped to cooperate with a port in a reader into which, when inserted properly oriented as aided by the appropriate indicia on the tag and inserted into the opening, will be in position to be read by the reader or reader and writer for use.

18. The information storage and access system of claim 10 in which the tag is folded so that the respective data storage devices and then interface connection areas are on opposite sides of the tag formed by folding the base and creating a tab for the interface contact areas and data readers for a particular use in some cases may be provided with a interface to connect the storage device to a reader for only one data area so that upon proper orientation using a visual guide on the tag the readable data area will be placed in position to be read by the reader.

19. A method of providing medical information for emergency treatment comprising
providing personal identification and emergency medical data relating to each of a plurality of people on personal small, lightweight data storage tags for each person, each tag having at least two data storage devices, one a read only storage device and the other a read and write storage area, so that the data stored in the read and write area are capable of not only being read but also being deleted, modified and/or added,
providing installations in emergency receiving stations, such as ambulances, hospital emergency rooms and other facilities for receiving and treating persons in need of urgent treatment, said installations including at least a reader capable of reading from the read only data storage area of the standard lightweight data tags, and an output display to produce a readable output for the emergency personnel,
providing read and write devices for installation in follow up medical facilities where doctors and their staffs can use them to access more comprehensive medical history information from a data tag, such that so that the medical history data can be read and produce a readable output for aid in diagnosis and treatment of the patient and those authorized can delete or change parts in need of correction or updating or add current data to the history, and
security means limiting access to authorized personnel after identification.
